(19) United States
(12) Patent Application Publication
(10) Pub. No.: US 2024/0430788 A1
(43) Pub. Date: Dec. 26, 2024

(54) ELECTRONIC DEVICE

(71) Applicant: Nordic Semiconductor ASA, Trondheim (NO)

(72) Inventors: Aki RANTALA, Oulu (FI); Samuli HEIKKINEN, Oulu (FI); Tuomo KUMENTO, Oulu (FI)

(73) Assignee: Nordic Semiconductor ASA, Trondheim (NO)

(21) Appl. No.: 18/674,499

(22) Filed: May 24, 2024

(30) Foreign Application Priority Data
Jun. 21, 2023 (GB) 2309360.2

(51) Int. Cl. H04W 48/16; H04W 48/08

(52) U.S. Cl. CPC H04W 48/16; H04W 48/08

(57) ABSTRACT

An electronic wireless communication device, comprising a memory region, storing a priority ordering of network identifiers, comprising at least a first wireless network identifier and a second wireless network identifier; and a network status indicator, having at least a first value and a second value. The electronic wireless communication device is arranged to carry out a network searching process, in which the electronic wireless communication device searches for available networks in an order defined by the priority ordering of network identifiers until an available network is identified and the electronic wireless communication device successfully connects to the available network. The electronic wireless communication device is arranged to omit at least the first network identifier from the priority ordering of network identifiers used during the network searching process whenever the network status indicator has the first value.

### CROSS REFERENCE TO RELATED APPLICATION

This application claims priority from Great Britain Application No. 2309360.2, filed Jun. 21, 2023, which application is incorporated herein by reference in its entirety.

### TECHNICAL FIELD

The present invention relates to an electronic wireless communication device and a method of operating an electronic wireless communication device.

### BACKGROUND OF THE INVENTION

It is known for electronic wireless communication devices connected to wireless voice and data networks to search periodically for available networks, other than the network to which they are currently connected, which they might connect to instead (e.g., if one of the other networks is assigned a higher priority). These periodic searches may be conditional on the device not already being connected to the highest priority network in the region that the device is located in (e.g., the highest priority network in the country). In other words, if a device is already connected to the highest priority network for the country it is in, it will not carry out periodic searches for other networks, otherwise the periodic searches are mandatory for a roaming device. It is known for such devices to include a subscriber identity module (SIM) (for example a universal integrated circuit card (UICC)), which may be virtual or physical. A network provider will provide the SIM, and can configure the relative priorities of a number of networks.

During these searches, the device must search first for the network that is highest in a priority ordering of network identifiers (stored on the device). This highest priority identifier in the ordering is always the home network identifier (home PLMN ID) that is configured for the device. Each device is configured with a home PLMN ID which identifies the operator of that device-it is the PLMN in which the device (or subscriber profile of the device) is defined or configured. The home PLMN defines a specific country (by a mobile country code) and a particular operator within that country (by a mobile network code). In many cases, this home PLMN ID identifies a physical network infrastructure that exists-such that the device is able to connect, when in the appropriate country, to the home network as identified by the home PLMN ID.

However, there are mobile network operators which are “virtual” operators, and which therefore do not have a home public land mobile network (PLMN). These operators are sometimes known as mobile virtual network operators (MVNOs). For such devices, it is impossible to connect to a home network corresponding to their defined home PLMN ID, since the network specified by that ID does not correspond to a physical network infrastructure. Despite this it is required for every SIM card to be configured with a home network ID, since this forms part of the identifier of the device. Since this home network ID is configured on the device, the device will search first for a network corresponding to this home network ID, whenever it carries out a new network search, despite the fact that such a network does not exist. Examples of when a new network search is carried out include a “higher priority PLMN search” whilst roaming, and also when a device is started for the first time with a new SIM card, and when certain types of rejects are received in a network connection attempt. This search wastes the device's power, and also delays the device from connecting to another wireless network. The present invention seeks to provide improvements to this known arrangement.

### SUMMARY OF THE INVENTION

From a first aspect, the invention provides an electronic wireless communication device, comprising:
a memory region, storing a priority ordering of network identifiers, comprising at least a first wireless network identifier and a second wireless network identifier; and
a network status indicator, having at least a first value and a second value;
wherein the electronic wireless communication device is arranged to carry out a network searching process, in which the electronic wireless communication device searches for available networks in an order defined by the priority ordering of network identifiers until an available network is identified and the electronic wireless communication device successfully connects to the available network;
wherein the electronic wireless communication device is arranged to omit at least the first network identifier from the priority ordering of network identifiers used during the network searching process whenever the network status indicator has the first value.

From a second aspect, the invention provides a method of operating an electronic wireless communication device, comprising:
assigning a network status indicator of the electronic wireless communication device a value, of at least a first value and a second value; and
the electronic wireless communication device carrying out a network searching process, in which the electronic wireless communication device searches for available networks in an order defined by a priority ordering of network identifiers, comprising at least a first wireless network identifier and a second wireless network identifier, until an available network is identified and the electronic wireless communication device successfully connects to the available network;
wherein the electronic wireless communication device omits at least the first network identifier from the priority ordering of network identifiers used during the network searching process whenever the network status indicator has the first value.

It will be understood that the term “available network” refers to a network that the electronic wireless communication device is within range of, and is capable of connecting to.

It will further be understood that whilst the network searches for available networks in an order defined by a priority ordering of network identifiers, it may not search through the entire set of network identifiers listed in the priority ordering, and in particular it will stop searching, even if it has only searched part of the ordering, as soon as it identifies an available network and the electronic wireless communication device has successfully connected to that available network.

By configuring a network status indicator in the electronic wireless communication device, and omitting at least a first network identifier from the priority ordering whenever this network status indicator has the first value (and optionally other values) this allows the electronic wireless communication device to always miss out one or more certain networks from the priority ordering every time a network search is carried out.

Thus, the electronic wireless communication device is able to avoid searching for certain network identifiers, where it may be known that such a search will never turn up a useful result, i.e. identify a network to which the electronic wireless communication device can usefully connect. Whilst it may be known for existing electronic devices to skip certain identifiers under certain specific circumstances (for example where they relate to networks which exist in countries other than the country where the device is currently located), the Applicant has identified that it is beneficial to enable the electronic wireless communication device to always omit certain identifiers from all network searching (or at least to omit them from all searches for as long as the network status identifier has a certain value).

It is said that the network status indicator has at least a first value and a second value. By this it will be understood that the network status indicator is able to have (i.e. able to be assigned) at least the first value and the second value. It will be understood however that the network status indicator is assigned, at a particular point in time (i.e. at any point in time), a value (i.e. one value, a single value). Thus, the electronic wireless communication device comprises a network status indicator, the network status indicator assignable (i.e. configured to be assigned) a (single) value of a set of values, the set of values comprising at least the first value and the second value (i.e. assignable (as its value) at least the first value and the second value). As explained further below, the assigned single value of the network status indicator may change over the lifetime of the electronic wireless communication device. Thus it need not always be assigned the same value of the set of values.

The network status identifier can be used, for example, to identify that one or more network identifiers in the priority ordering do not correspond to physically existing networks. In such a case, searching for a network corresponding to that network identifier is futile. Thus, by always omitting such network identifiers from the priority ordering when carrying out a network search, the electronic wireless communication device is able to connect more quickly to a network, since time is not wasted searching for non-useful (e.g., non-existent) networks. Furthermore, power usage of the device will also be improved as a result, since power is not wasted carrying out futile network searches.

When the network status indicator has the second value, the electronic wireless communication device will not always omit the first network identifier from the priority ordering of network identifiers. Nonetheless, there may be certain circumstances, or certain types of searches, in which the first wireless network identifier is still omitted from the priority ordering (i.e. where those networks are not suitable, for example if their mobile country code indicates that they are in a different country to where the device is located). The electronic wireless communication device may be configured such that whenever the network status indicator has the second value, all network identifiers in the priority ordering are available for inclusion in the network searching process, i.e. even though in a specific search, under specific circumstances, some identifiers are omitted.

In some embodiments, the network status indicator having the first value indicates that the first network identifier does not correspond to a physical network infrastructure (i.e. to a public land mobile network), and wherein the network status indicator having the second value indicates that the first network identifier does correspond to a physical network infrastructure.

Thus, the network status indicator having the first value may indicate that the electronic wireless communication device is associated with a mobile operator that does not have a home public land mobile network, and the network status indicator having the second value may indicate that the electronic wireless communication device is associated with a mobile operator that has a home public land mobile network.

In some embodiments, the first network identifier may be an identifier of a home network (i.e. an identifier of a network associated with a mobile operator of the device, e.g. an operator being the supplier of a subscriber identity module that is present within the device). The first network identifier may be a home public-land-mobile-network identifier, a PLMN ID.

In some embodiments, the network status indicator is a home-network status indicator, i.e. indicating a status of a home-network. The home-network status indicator may indicate whether the first network identifier, which is an identifier of the home-network, does or does not correspond to a physical network infrastructure.

It will be appreciated that the first wireless network identifier is the first identifier in the priority ordering of identifiers. The second wireless network identifier may immediately (i.e. directly) follow the first wireless network identifier in the priority ordering. Thus, the electronic wireless communication device may search first for a network corresponding to the second network identifier, during a network search, when the network status indicator has the first value.

Based on the network status indicator having the first value, the electronic wireless communication device may (always) omit only the first network identifier from the priority ordering used during the network searching process, or it may alternatively omit one or more further network identifiers from the priority ordering. These one or more further network identifiers may otherwise (sometimes) be included in the priority ordering provided that the network status indicator has the second value.

Additionally or alternatively the electronic wireless communication device may comprise one or more further network status identifiers. The electronic wireless communication device may be arranged to omit at least one further network identifier from the priority ordering of network identifiers used during the network searching process whenever the further network status indicator has a third value. The third value may be the same as the first value, or may be different. Each further network status identifier may correspond to an associated network identifier (i.e. there is one status indicator for each network ID that is to be omitted).

In some embodiments, the priority ordering of network identifiers further comprises one or more additional wireless network identifiers (i.e. in addition to the first and second wireless network identifiers).

In some embodiments, the priority ordering further comprises a list of one or more network identifiers associated with networks that are related to the network identified by the first wireless network identifier (e.g. the home network). This list may immediately follow the first wireless network identifier in the priority ordering. The electronic wireless communication device may be arranged to omit the list of one or more network identifiers associated with networks that are related to the network identified by the first wireless network identifier from the priority ordering used during the network searching process, whenever the network status indicator has the first value. Thus, the electronic wireless communication device also does not search for certain networks associated with the home network, sometimes called home-equivalent networks, whenever (i.e. as long as) the network status indicator has the first value. Alternatively, only certain network identifiers of the list may be omitted (i.e. at least one network identifier from the list), either based only on the network identifier, or alternatively based on the value of one or more further network identifiers.

In some embodiments, the priority ordering of network identifiers comprises a user-controlled list of network identifiers. In some embodiments, in addition or alternatively, the priority ordering of network identifiers comprises an operator-controlled list of network identifiers (i.e. controlled by the mobile operator associated with the electronic wireless communications device).

The electronic wireless communication device may be arranged to not omit the second wireless network identifier whenever the network status indicator has the first value, i.e. to not omit the second wireless network identifier based on the value of the network status indicator (although it may be omitted from the priority ordering used for a particular network searching process for some other reason). The electronic wireless communication device may be arranged to include the second wireless network identifier in the priority ordering whenever the network status indicator has the first value or the second value (e.g. regardless of the value of the network status indicator).

The priority ordering of network identifiers is stored in a memory region. The method may comprise storing the priority ordering in the memory region, or this storing may be carried out before the claimed method takes place.

As explained in greater detail below, the network status indicator may be, or may be derived from, a network identifier of the priority ordering, and thus the network status indicator may also be stored in the first memory region by virtue of being part of the priority ordering. The network status indicator may, alternatively, be separate from the priority ordering of identifiers, but may be stored in the (first) memory region, i.e. the same memory region as the priority ordering. Alternatively, in other embodiments, the electronic wireless communication device comprises a second memory region (e.g. located in a separate memory, separate from a first memory which comprises the first memory region), in which the network status indicator may be stored.

As stated above, the network status indicator has at least a first value and a second value. The network status indicator may have only either a first value or a second value, i.e. the network status indicator may be binary. Alternatively, the network status indicator may have additional (possible, assignable) values (i.e. more than two values). It will be appreciated that at any given time the network status indicator will be assigned a single value of the two (or more) values. The network status indicator may directly indicate a status relating to one or more networks in the priority ordering (i.e. its value may indicate this directly). Alternatively, a status relating to one or more networks in the priority ordering (and therefore whether to omit the first identifier from the priority ordering) may be derivable based on the value of the network status indicator e.g., by comparing the value of the network status indicator to one or more pre-set values.

The priority ordering of network identifiers may be (partially or fully) defined by the mobile operator associated with the electronic wireless communication device (e.g. based on costs agreed between the mobile operator associated with the device and between operators of the available networks). Thus, the method may comprise defining, by a mobile operator associated with the electronic wireless communication device the priority ordering of network identifiers. It will be understood that where a mobile operator is said to be associated with a device, that may be directly, or may be indirectly, by virtue of the mobile operator being the supplier of a subscriber identity module that is present within the device, as discussed further below. The priority order or value of the networks may be defined or configured (e.g. stored) on the subscriber identity module.

The priority ordering of network identifiers may be (at least partially) defined by a user of the electronic wireless communication device.

In some embodiments, the electronic wireless communication device comprises a subscriber identity module which assigns an identification to the electronic wireless communication device. The subscriber identity module may be provided by a circuit card. The mobile operator associated with the electronic wireless communication device typically supplies the subscriber identity module and may therefore control the contents of the subscriber identity module, and thereby have greater control over the subsequent operation of the electronic wireless communication device. In some embodiments, the subscriber identity module stores the (value of) the network status indicator. In some embodiments, the subscriber identity module comprises the memory region (which may be a first memory region), i.e. storing the priority ordering. In some embodiments, the electronic wireless communication device comprises a second memory region (e.g. outside the subscriber identity module), wherein the second memory region stores the network status indicator.

In some embodiments, the value of the network status indicator is assigned by a mobile operator.

In some embodiments, the value of the network status indicator is user configurable (i.e. so that a user is able to select (and possibly vary) the status of the electronic wireless communication device as being a device associated with a home public land mobile network, or a device not associated with such a network, i.e. having a virtual operator). For example, the value of the network status indicator may be configurable in an application running on the electronic wireless communication device. Thus, in some embodiments, the method of operating the electronic wireless communication device further comprises assigning and/or changing, by a user, the value of the network status indicator.

The network status indicator may comprise a (mobile) wireless network identifier (e.g. it may be a mobile network identifier) which may be associated with the electronic wireless communication device. The mobile wireless network identifier may comprise (or may be) a mobile country code and/or a mobile network code.

The electronic wireless communication device may be arranged to determine whether to omit at least the first network identifier from the priority ordering of network identifiers used during the network searching process by comparing the value of the network status indicator to one or more pre-set values (e.g. a list or range of network identifiers). The pre-set values may correspond to mobile network identifiers that are associated with operators that do not have their own public land mobile network (e.g. a list of mobile network identifiers, or a range of identifier values, for example a range of MCC and/or MNC values, for example which are known to correspond to non-physical networks). Thus, the electronic wireless communication device may comprise a (second) memory region storing values of one or more pre-set values (e.g. of mobile network identifiers). This may be the same memory region as the memory region storing the priority ordering, or it may be a second memory region, e.g. separate from the (first) memory region that stores the priority ordering. The method may comprise comparing the value of the network status indicator (i.e. of the mobile network identifier associated with the electronic wireless communication device) with one or more pre-set values.

In some embodiments, the electronic wireless communication device may advantageously be arranged to omit a home-network identifier from the priority ordering based on a home-network status indicator, and may further be arranged to omit one or more additional network identifiers from the priority ordering based on comparing the value of one or more further network status indicators (e.g. the network identifiers) to one or more pre-set values. Thus, in some embodiments the electronic wireless communication device further comprises a second memory region (which may be part of or separate from the memory region storing the priority ordering) storing values of one or more pre-set values, the first wireless network identifier is an identifier of a home network, and the electronic wireless communication device is further arranged to determine whether to omit the second network identifier from the priority ordering of network identifiers used during the network searching process by comparing the second network identifier (or at least a part of the second network identifier) to the one or more pre-set values.

The network status indicator may be one or more network identifiers of the priority ordering (e.g. the first network identifier). In other words, part or all of the first identifier of the priority ordering may provide the network status identifier. Thus, the electronic wireless communication device may determine whether or not to omit the first network identifier from the priority ordering whenever a network searching process is carried out, based on the value of (some or all of) the first network identifier itself. Thus, the memory region may effectively store both the priority ordering and also the network status indicator (since the priority ordering comprises the network status indicator).

The network status indicator may have a fixed value, e.g. for the lifetime of the wireless electronic device. In some embodiments, the network status indicator may be configurable only once, i.e. it will then have this value for the lifetime of that device. Alternatively, the electronic wireless communication device may be arranged such that the value of the network status indicator is variable, i.e. it may be changed throughout the lifetime of the device. This may be helpful in case, for example, the operator associated with a device does not own a network infrastructure when the device is first commissioned, but later acquires a network infrastructure. This may also be helpful where the SIM in a device is changed, to a new SIM which is associated with a physical home network, particularly where the network status indicator is configured on the electronic wireless communication device, outside of the SIM.

The electronic wireless communication device may be arranged to carry out the network searching process if the electronic wireless communication device is connected to a network other than the first network specified in the priority ordering (e.g. connected to a network that is not the highest priority network in the list, or at least the highest applicable network in the priority ordering, for example in the relevant country). The electronic wireless communication device may be arranged to carry out the network searching process periodically, at intervals defined by a search period (e.g. under certain circumstances, such as when the electronic wireless communication device is roaming).

Alternatively, or in addition, the electronic wireless communication device may be arranged to carry out the network searching process upon start-up (e.g. for the first time) of the electronic wireless communication device.

Alternatively, or in addition, the electronic wireless communication device may be arranged to carry out the network searching process following rejection of an attempt to connect to a wireless network.

In some embodiments, the method further comprises the electronic wireless communication device establishing a connection (e.g. registering with) a wireless network identified in the network searching process. It will be appreciated that the invention described herein alters the way in which the electronic wireless communication device searches for available networks, but is not intended to restrict the electronic wireless communication device in connecting to networks identified in its search, i.e. it does not blacklist any network for connection. Thus, if a network is omitted from the priority order for searching due to the value of the network status indicator, but nonetheless is somehow found during the device's searching process, the electronic wireless communication device is able (i.e. permitted) to connect to this network. Thus the electronic wireless communication device may be arranged to be capable of connecting to the network corresponding to the first wireless network identifier even when the first wireless network identifier is omitted from the priority ordering.

In some embodiments, the electronic wireless communication device comprises a network status indication portion, arranged to store the network status indicator. The network status indication portion may be a register (e.g. a memory register) arranged to store the value of the status indicator.

In some embodiments, the electronic wireless communication device comprises a network search portion, wherein it is the network search portion that is arranged to carry out the network searching process. For example, the network search portion may be arranged to periodically search, at intervals defined by a search period, for available networks of the plurality of wireless networks, e.g. other than a wireless network to which the electronic wireless communication device is connected.

The electronic wireless communication device may be a device other than a mobile telephone. The electronic wireless communication device may be a sensor, e.g. a movement sensor and/or a location sensor, i.e. in the sense that its primary purpose is for sensing. Such devices may have particularly strict energy constraints and therefore the energy saving provided by the invention set out above may be particularly advantageous for such devices.

Features of any aspect or embodiment described herein may, wherever appropriate, be applied to any other aspect or embodiment described herein. Where reference is made to different embodiments or sets of embodiments, it should be understood that these are not necessarily distinct but may overlap. It will furthermore be understood that references made to a method comprising a step correspondingly extend to a module “configured to” carry out a step, and vice versa.

### BRIEF DESCRIPTION OF THE DRAWINGS

An embodiment of the invention will now be described, by way of example only, with reference to the accompanying drawings, in which:

FIG. 1 is a schematic diagram of an exemplary communications network including a wireless electronic communication device in accordance with a first embodiment of the present invention;

FIG. 2 is a schematic diagram representing a priority ordering, as stored in the electronic wireless communication device of FIG. 1;

FIG. 3 is a schematic diagram of a wireless electronic communication device in accordance with a second embodiment of the present invention;

FIG. 4 is a schematic diagram of a wireless electronic communication device in accordance with a third embodiment of the present invention;

FIG. 5 is a flow diagram representing a method according to an embodiment of the present invention.

### DETAILED DESCRIPTION

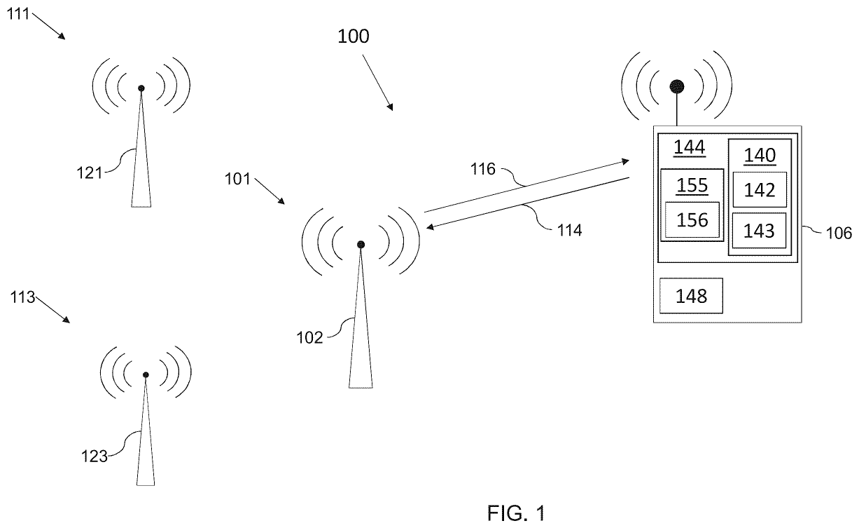

FIG. 1 shows a schematic diagram of an exemplary radio communications system 100. The exemplary radio communications system 100 includes a first network 101, and an electronic wireless communication device 106 (also referred to as user equipment, or UE), which is connected to the first network 101. The first network 101 includes a base station radio transceiver 102. There are also other (second and third) networks 111, 113, each including respective base stations 121, 123, to which the electronic wireless communication device 106 is not presently connected at the time instant represented by FIG. 1.

Each of the base stations 102, 121, 123 and the electronic wireless communication device 106 are arranged to transmit and receive wireless radio signals.

The UE 106 is connected to the first network 101, and therefore the base station 102 is in wireless radio communication with the UE 106, and can thus transmit wireless signals to, and receive wireless signals from the UE 106.

In order to transmit information to the base station 102, the UE 106 transmits a first uplink signal 114 which is addressed to the base station 102, and the base station 102 receives this first uplink signal 114.

In order to transmit information to the UE 106, the base station 102 transmits a first downlink signal 116 which is addressed to the UE 106, and the first UE 106 receives this first downlink signal 116.

The base stations 102, 121, 123 and UE 106 are configured to operate in accordance with a predetermined communication protocol-which in this particular embodiment is LTE, though the principles outlined herein are not limited to LTE and may be equally applied to other predetermined communication protocols e.g. Wi-Fi, Bluetooth, etc.

In this example, the UE 106 is using a Mobile Virtual Network Operator (MVNO). An MVNO is a wireless communications provider that doesn't own its own wireless network infrastructure. Such a UE 106 does not have a “home network”. As set out above, this means that the home network identifier (home PLMN ID) that is set for the UE 106 does not correspond to a physical network infrastructure that exists. Thus, such a device cannot connect to its “home network” (i.e. to the network identified by its home PLMN ID). Instead, it will always be “roaming” and trying to connect to networks 101, 111, 113 with which its mobile operator has existing agreements.

The UE 106 includes a network searching portion 148. The network searching portion 148 searches for available networks, such as the first network 101, the second network 111 and the third network 113. This search may be carried out under various circumstances. Under some circumstances, when needing to connect to a network, the UE 106 will first attempt to re-connect a previously registered network, i.e. a network with which the UE 106 has previously exchanged the necessary messages to successfully register with that network (e.g. first network 101). However, in other circumstances the UE 106 will need to carry out a network searching process.

By way of background, there are many cases in which a UE must carry out the network searching process to search afresh for a new network to connect to.

For example, where a new, previously unused subscriber identity module (SIM) is placed in the device which has not been used previously, there will be no existing registered network (PLMN) and therefore a new network search must be carried out.

When a UE attempts to connect to a previously unknown network, that network may reject the registration attempts, and provide a reason for that rejection to the UE. Certain reasons may trigger the UE to start a new network searching process.

In order for UEs to be connected to the most appropriate network, a priority ordering of networks will be defined for the UE. The priority ordering may be fully configured by the MVNO, when configuring the device initially (i.e., when configuring the SIM card of the device), or it may at least partially be later configured by a user. The priority ordering may be based on the agreements that the MVNO has with operators of the various network infrastructures, for example based on the agreed costs.

If not connected to the highest priority network in the priority ordering, the UE will periodically carry out the network searching process to search for a higher priority network to connect to. The period at which this search must be carried out is often configured on the SIM card of the device. The highest priority network may be the highest priority network overall in the priority ordering, or may be the highest priority network in the ordering that is applicable for the UE, for example by being a network located in the same country as the UE is located. As discussed further below, where the UE is located in the same country as its “home network”, this will be the highest priority network in the priority ordering, and therefore the network for which the UE must search first.

When carrying out these new network searches, a UE generally searches one-by-one for each network ID in the order they are identified in the priority ordering for the device. As a result, when searching for a new network it is often the case that existing UEs will need to search for their home network first, before searching for other networks lower down the priority ordering. However, as set out above, for UEs that are associated with virtual operators, there will be no home network, and therefore this search is wasted.

Returning to consider the embodiment of FIG. 1, according to the present invention, the UE 106 stores a network status indicator 142, and the UE 106 is configured to omit at least the home network identifier from its priority ordering for a network search, whenever the network status indicator 142 has a first value. This allows the home network to be skipped during all network searches, under any circumstances, so that where the home network does not exist, time and energy is not wasted by the UE 106 searching for the home network.

The UE 106 includes a subscriber identity module (SIM), which in this example is a universal integrated circuit card (UICC) 144. In the example of FIG. 1, the priority ordering 156 is stored in a first memory region 155 which is located within the UICC 144.

The UE 106 includes a second memory region 140, which is also located within the UICC 144. A network status indicator 142 is stored in the second memory region 140. In this example, the value of the network status indicator 142 is configured on the UICC 144 by the network operator when creating the UICC 144.

In this example, the network status indicator 142 has two possible values. A first value (e.g. 1) indicates that there is no home network associated with operator of the UICC 144, and therefore with the UE 106. A second value (e.g. 0) indicates that there is a home network associated with the network operator.

Where the network status indicator 142 has the second value, the network searching portion 148 of the UE 106 will search (when required) for a new network by searching in turn for all of the (applicable) networks defined in the priority ordering 156, stored on the UICC 144.

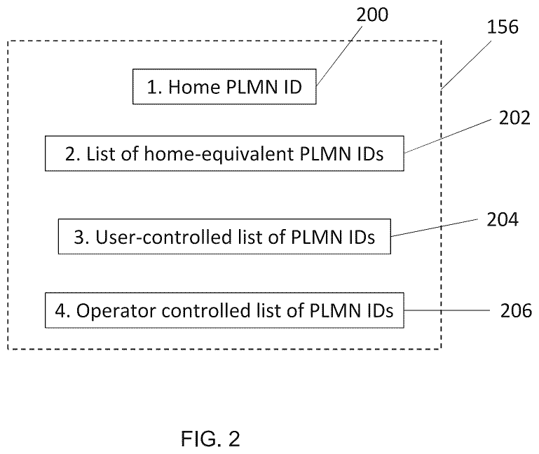

An exemplary priority ordering 156 is shown in FIG. 2. The priority ordering is a list of network identifiers, listed in a defined priority ordering. Each network identifier is made up of a mobile country code (MCC), indicating the country that is covered by the network, and a mobile network code (MNC).

As mentioned above, certain identifiers (also referred to as IDs) may be omitted from the ordering in certain circumstances, e.g. where they correspond to a network that covers a country in which the UE 106 is not presently located. However it is not known for existing devices to have certain IDs which are always omitted from the priority ordering when searching, based on the value of a network status indicator 142.

The first ID in the priority ordering 200 for all devices will be the home network ID, also referred to as the HPLMN ID that is associated with the operator of that UE (i.e. of the SIM card of that UE). For some operators, this home PLMN ID corresponds to a public land mobile network that physically exists, however, some other operators (MVNOs) do not own a physical network infrastructure, but instead have arrangements with other operators to use their network infrastructures. For UEs, such as the UE 106 of FIG. 1, that have SIM cards from these “virtual” operators, a search based on the home PLMN ID will never find a useful network. Nonetheless, it is a requirement for the home PLMN ID to be specified as the first ID in the priority ordering 200 for all UEs 106, not least because this home PLMN ID is used to derive an identifier for the device, referred to as an International Mobile Subscriber Identifier (IMSI). The IMSI for a particular UE 106 is defined by the home PLMN ID associated with the operator of that UE 106, together with a unique ID that is unique to the UE 106 (e.g. to the UICC 144 of the UE 106). Thus, a home PLMN ID must be defined for each UE 106, and specified in its priority ordering 156, regardless of whether that home PLMN ID does not identify a physical network to which the UE 106 could connect. The UICC 144 stores the international mobile subscriber identity (IMSI) number and its related key.

The other IDs in the priority ordering are grouped into three separate categories.

Second in the priority ordering 202 is a list of home-equivalent PLMN IDs. For some UEs this list may not be present in the priority ordering, i.e. if there are no other networks that are equivalent to the home network. A network may be equivalent to the UE's home network where it is another network being operated by the same operator as is associated with the home PLMN ID, or operated by another operator with which the home network operator has an agreement that the networks are equivalent. For the purposes of the IMSI, as discussed above, a UE 106 must be associated with one specific home PLMN ID, but the second group in the priority ordering 202 allows the operator to specify additional networks (by their identifiers) which are effectively equivalent to the home network. UEs may be configured so that they are not required to search for a higher priority network in the event that they are already connected to a network whose ID is listed in this second group 202.

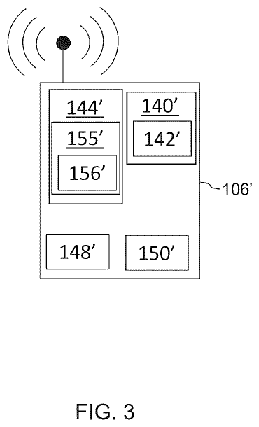

Next, third in the priority ordering 204 there may optionally be a list of PLMN IDs that are specified and controlled by a user of the UE 106. This allows a user to input certain network IDs that they wish to be searched for after the home network and any home-equivalent networks. This may be input through application 150′ that is discussed below with reference to the second embodiment shown in FIG. 3, or may be input through a separate application on the UE 106. Alternatively, there may be no IDs listed in this group.

Fourth (and final) in the priority ordering 206 is a list of PLMN IDs, in their own priority ordering, that have been configured by the mobile network operator. The network IDs in this list 206 relate to networks with which the mobile network operator associated with the UE 106 has established relationships (i.e. roaming agreements). The priority order in which these networks are placed may be determined based on the relative costs of these agreements.

When carrying out a network search, the UE 106 must search through the IDs listed in this priority ordering 156 one by one, until it successful connects to one of the networks. If the UE 106 searches the entire list and does not connect to any network successfully, it can connect with other networks that it finds (that are not included in the priority ordering 156), giving preference to high quality networks. It tries to attach to any networks it finds, in a random order, but once connected to one of these non-priority networks it will be obliged to search again periodically (based on the configured search period, which may be, e.g. every minute) through the networks listed in the priority ordering 156 to see if it can connect to one.

As set out above, it may be futile for the UE 106 to search for a network corresponding to the first entry in the priority ordering 200, the home PLMN ID, since this may not correspond to a physical network. This is the case for the UE 106 of FIG. 1.

The network status indicator 142 of the UE 106 has its value set to a first value (e.g. 0). This indicates to the UE 106 that the home network specified by the home PLMN ID does not correspond to a physical network. The UE 106 according to the present invention is configured to omit the first “group” 200 (the home PLMN ID) from the priority ordering 156, whenever this priority ordering 156 is used to carry out a network search.

Thus, the UE 106 will start by searching for any IDs in the second group 202 (if any are present), and then move on to search, in order, through the network IDs in the third group 204, and then through the network IDs that are specified by the operator, those located in the fourth group 206 of the priority ordering.

Thus, whatever searching the UE 106 carries out, provided the value of the network status indicator 142 is set to the first value, the UE 106 will not ever search for a network corresponding to the home network ID when carrying out a network search (e.g. even where the UE 106 is located in the same country as the country indicated by the MCC of the home PLMN ID). This reduces the time taken for the UE 106 to successfully connect to a network, since time is not wasted searching for physical networks that do not exist, and it therefore also reduces power consumption of the UE 106.

For example, where network 101, to which the UE 106 is connected, is a network not featured on the priority ordering 156, the UE 106 will be obliged to search for the networks defined by the IDs in the priority ordering 156 periodically. When carrying out such a periodic network search, the UE 106 according to the present invention will begin by immediately searching for the first ID in the second group 202, or in the third group 204 if there are no home-equivalent networks (i.e., no IDs in the second group 202), or in the fourth group 206 if no IDs are present in the user-controlled list. This avoids futile searching for a non-existent home network.

It is possible that one or more additional network IDs in the priority ordering 156 (for example some or all of the IDs in the second group 202) do not correspond to a physical network. For example, an operator whose network appeared in the second group 202 may have ended business. The UE 106 may also be configured such that the network status indicator 142 having the first value indicates that one or more further networks specified by additional IDs (e.g. the IDs in the second group 202) do not correspond to a physical network, and therefore the UE 106 may omit multiple network IDs from the priority ordering based on the network status indicator 142 having the first value. Additionally or alternatively the UE 106 may comprise one or more further network status identifiers, used to indicate that other network identifiers are to always be omitted from the priority ordering. Each further network status identifier may correspond to an associated network identifier (i.e. there is one status indicator for each network ID that is to be omitted).

Although in this example the network status indicator 142 (and optionally also further network status indicator 143) is stored in a memory 140 of the UICC 144, it may alternatively be stored in a memory (e.g. RAM) elsewhere in the UE 106, as illustrated in the second embodiment, shown in FIG. 3. In this embodiment, like components have been labelled with the same reference numerals as in FIG. 1, but followed by an apostrophe. These like components will not be described here again, but rather only the differences as compared to the embodiment of FIG. 1 will be described.

In this embodiment, the second memory region 140′ in which the network status indicator 142′ is stored is not located in the UICC 144′, but rather is located elsewhere in the UE 106′. The UE 106′ further includes a user application 150′. The application 150′, when run by the UE 106′ allows a user to configure (i.e., select) a value of the network status indicator. Thus, the user of the UE 106′ inputs into the application 150′ whether the operator of the UICC 144 is associated with a home network or not, and the network status indicator value is set to reflect this information. The application 150′ may also allow the user to change the value of the network status indicator, after it has initially been set.

In both of the examples above, the network status indicator 142, 142′ has a binary value, with a first value indicating that the home network ID does not correspond to a physical network, and the second value indicating that it does.

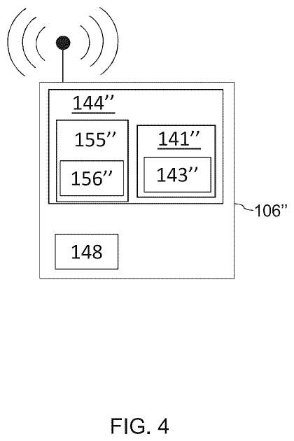

Alternatively, the status indicator 142″ may be arranged to have additional values (i.e., more than just two), as explained below with reference to a third embodiment, illustrated in FIG. 4. Again, like components have been labelled with the same reference numerals as in FIGS. 1 and 3, but this time followed by two apostrophes (compared to the reference numerals of FIG. 1). These like components will not be described here again, but rather only the differences as compared to the embodiments of FIGS. 1 and 3 will be described.

In this embodiment of FIG. 3, the UE 106″ again includes a UICC 144″, which stores a priority ordering 156″ in a memory 155″. In this example, no separate network status indicator is stored on the UE 106″. Instead, the home PLMN ID, i.e. the first entry in the priority ordering 156″ is used as the network status indicator. In order to determine whether or not to include the home PLMN ID (and equivalents) in network searching, the UE 106″ compares the home PLMN ID (or some part of the home PLMN ID, such as the MCC) to a list of one or more pre-set values 143″, stored in a second memory region 141″ of the UICC 144″.

The list of pre-set values 143″ may, for example, include some (or all) network identifiers that are not associated with physical networks. The home PLMN ID (which in this example provides the network status identifier) is compared with this list by the UE 106″. If the home PLMN ID appears on this list of pre-set values 143″ this indicates there is no physical network corresponding to the home PLMN ID. Therefore, the UE 106″ always omits this ID from the search whenever it searches for a new network. Alternatively, if the home PLMN ID does not correspond to an identifier on the list of pre-set values 143″, then the UE 106″ may include it in the priority ordering, so that it may search for a network corresponding to the home PLMN ID when searching for a new network.

Although in this example the list of pre-set values 143″ is a list of one or more network identifiers, in other examples the pre-set values may indicate values (such as an MCC or MNC) against which a part of the home PLMN ID is compared (rather than the entire identifier). Thus, in some examples, if the PLMN ID has an MCC in a certain, pre-defined range (i.e. the stored pre-set values), then the home network is known to be non-physical and is not searched (i.e. is always omitted from the priority ordering). Alternatively, a memory of the UE 106″ may store a rule relating to the network identifiers, against which the home PLMN ID is compared. For example, the second memory region 143″ may store a rule indicating that all network identifiers having a mobile country code starting with a value “9” correspond to home PLMN IDs that are not associated with physical networks. Thus, based on the value of the home PLMN ID itself, the UE 106″ is able to determine whether this should be included (as appropriate) in the priority ordering of networks through which the UE 106″ searches when seeking a new network, or whether the home PLMN ID should be omitted from the ordering.

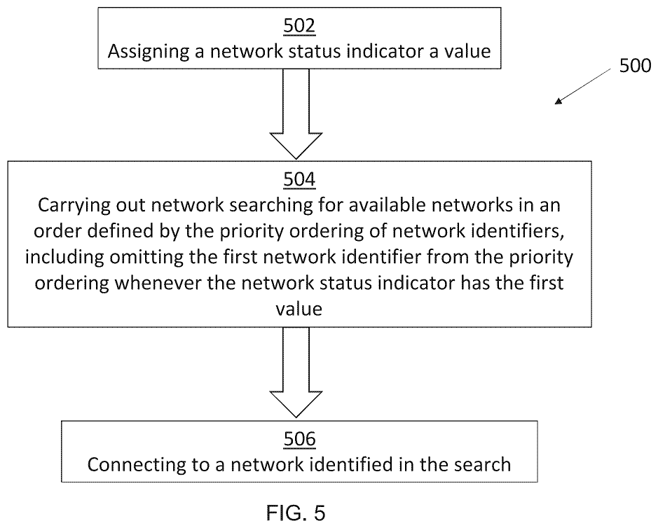

FIG. 5 is a flow diagram representing a method 500 according to an embodiment of the present invention.

In a first stage 502, a network status indicator of the electronic wireless communication device is assigned a value of at least two values.

Next, at stage 504, the electronic wireless communication device carries out a network searching process, in which the electronic wireless communication device searches for available networks in an order defined by the priority ordering of network identifiers, until an available network is identified and the electronic wireless communication device successfully connects to the available network. The electronic wireless communication device omits at least the first network identifier from the priority ordering of network identifiers used during the network searching process, whenever the network status indicator has the first value (i.e. based on the network status indicator having the first value).

Then, at stage 506, the electronic wireless communication device connects to a network identified in the search.

1. An electronic wireless communication device, comprising:
a memory region, storing a priority ordering of network identifiers, comprising at least a first wireless network identifier and a second wireless network identifier; and
a network status indicator, having at least a first value and a second value;
wherein the electronic wireless communication device is arranged to carry out a network searching process, in which the electronic wireless communication device searches for available networks in an order defined by the priority ordering of network identifiers until an available network is identified and the electronic wireless communication device successfully connects to the available network;
wherein the electronic wireless communication device is arranged to omit at least the first network identifier from the priority ordering of network identifiers used during the network searching process whenever the network status indicator has the first value.

2. The electronic wireless communication device of claim 1, wherein the network status indicator having the first value indicates that the first network identifier does not correspond to a physical network infrastructure and wherein the network status indicator having the second value indicates that the first network identifier does correspond to a physical network infrastructure.

3. The electronic wireless communication device of claim 1, wherein the first network identifier is an identifier of a home network associated with a mobile operator of the electronic wireless communication device.

4. The electronic wireless communication device of claim 1, wherein the network status indicator has only either the first value or the second value.

5. The electronic wireless communication device of claim 1, wherein the network status indicator comprises a wireless network identifier.

6. The electronic wireless communication device of claim 5, wherein the network status indicator is one or more network identifiers of the priority ordering, or wherein the network status indicator is derived from one or more network identifiers of the priority ordering.

7. The electronic wireless communication device of claim 1, wherein the value of the network status indicator is user configurable.

8. The electronic wireless communication device of claim 1, wherein the electronic wireless communication device is arranged to determine whether to omit at least the first network identifier from the priority ordering of network identifiers used during the network searching process by comparing the value of the network status indicator to one or more pre-set values.

9. The electronic wireless communication device of claim 8, wherein the electronic wireless communication device comprises a second memory region, storing the one or more pre-set values.

10. The electronic wireless communication device of claim 1, wherein the priority ordering further comprises a list of one or more network identifiers associated with networks that are related to the network identified by the first wireless network identifier.

11. The electronic wireless communication device of claim 10, wherein the electronic wireless communication device is arranged to omit at least one network identifier from the list of one or more network identifiers from the priority ordering used during the network searching process, whenever the network status indicator has the first value.

12. The electronic wireless communication device of claim 1, wherein the electronic wireless communication device further comprises a second memory region storing values of one or more pre-set values, the first wireless network identifier is an identifier of a home network, and wherein the electronic wireless communication device is further arranged to determine whether to omit the second network identifier from the priority ordering of network identifiers used during the network searching process by comparing at least a part of the second network identifier to the one or more pre-set values.

13. The electronic wireless communication device of claim 1, wherein the priority ordering of network identifiers comprises a user-controlled list of network identifiers; and/or wherein the priority ordering of network identifiers comprises an operator-controlled list of network identifiers.

14. The electronic wireless communication device of claim 1, wherein the electronic wireless communication device comprises a subscriber identity module which assigns an identification to the electronic wireless communication device.

15. The electronic wireless communication device of claim 14, wherein the subscriber identity module stores the value of the network status indicator.

16. The electronic wireless communication device of claim 1, wherein the network status indicator is stored in the memory region; or wherein the electronic wireless communication device comprises a second memory region, and wherein the network status indicator is stored in the second memory region.

17. A method of operating an electronic wireless communication device, comprising:
assigning a network status indicator of the electronic wireless communication device a value, of at least a first value and a second value; and
the electronic wireless communication device carrying out a network searching process, in which the electronic wireless communication device searches for available networks in an order defined by a priority ordering of network identifiers, comprising at least a first wireless network identifier and a second wireless network identifier, until an available network is identified and the electronic wireless communication device successfully connects to the available network;
wherein the electronic wireless communication device omits at least the first network identifier from the priority ordering of network identifiers used during the network searching process whenever the network status indicator has the first value.

18. The method of claim 17, wherein the value of the network status indicator is assigned by a mobile operator.

19. The method of claim 17, further comprising assigning and/or changing, by a user, the value of the network status indicator.

20. The method of claim 17, further comprising the electronic wireless communication device establishing a connection with a wireless network identified in the network searching process.
